(19) United States
(12) Patent Application Publication
(10) Pub. No.: US 2005/0061877 A1
(43) Pub. Date: Mar. 24, 2005

(54) System and method for unattended delivery

(76) Inventor: John Stevens, Starbum, NH (US)

Correspondence Address: MCGINN & GIBB, PLLC, 8321 OLD COURTHOUSE ROAD, SUITE 200, VIENNA, VA, 22182-3817, US

(21) Appl. No.: 10/478,474

(22) PCT Filed: May 21, 2002
(86) PCT No.: PCT/US02/16019

Related U.S. Application Data
(60) Provisional application No. 60/291,962, filed on May 21, 2001.

(51) Int. Cl. G06F 17/60

(52) U.S. Cl. 235/385

(57) ABSTRACT

An inventive system and method for unattended delivery of goods includes an electronic tag associated with the item and having a first transceiver, and a drop box located at the destination for the item, the drop box having a second transceiver which wirelessly communicates with the first transceiver to allow access to the drop box.

### CROSS REFERENCE TO RELATED APPLICATIONS

This application claims the benefit of U.S. Provisional Application No. 60/291,962 which was filed on May 21, 2001 by John Stevens, and assigned to the present assignee, and which is incorporated herein by reference.

### BACKGROUND OF THE INVENTION

1. Field of the Invention

The present invention relates to a system and method for delivering packages, and in particular, a system and method for delivering packages to a destination which is unattended.

2. Description of the Related Art

A number of companies have developed businesses where customers select and purchase grocery items or dry goods online using the world wide web. The companies inventory these items in a local warehouse and deliver the groceries and dry goods items directly to a customer's door. Often the customer can arrange for the goods to be delivered to his home or business at a time when the customer knows he will be in. However, in some instances no such arrangement can be made. In those cases, where the destination is unattended, the goods may be, for example, delivered to a refrigerator stored in the customer's garage or outbuilding, the door to which the driver can open using a keypad entry code provided by the customer.

In any event, the customer is charged a delivery fee that represents only a portion of the actual delivery costs incurred by the vendor. The vendor derives the remaining costs from margin or profit on the product itself. The rationale is that it would cost much less to operate a warehouse and cover a portion of the delivery cost from product profit margin than to run a conventional retail store and the necessary warehouses to supply the retail store. Moreover, a consumer obtains enhanced convenience over conventional retail stores since the goods are delivered directly to the customer's front door and pricing may be at least competitive with a retail store.

However, delivery service companies are finding it hard to make a profit. One reason is that the cost of attended delivery is high, requiring both a high minimum order and a high delivery fee to insure profitability of the company. Unattended delivery is more popular with customers, however, delivery companies have been unable to profitably implement unattended delivery systems.

Therefore, although demand for such delivery service appears to be high, few internet-based delivery services have been successful and most appear to be failing. Indeed, while some companies providing such services are beginning to claim “operational profitability”, none have actually achieved profitability and, in fact, several of the companies have even gone bankrupt.

### SUMMARY OF THE INVENTION

In view of the foregoing and other problems, disadvantages, and drawbacks of the conventional methods and structures, an object of the present invention is to provide a system and method for unattended delivery.

The present invention includes an inventive system for unattended delivery of an item. The inventive system includes an electronic tag associated with the item and having a first transceiver, and a drop box located at the destination, the drop box having a second transceiver which wirelessly communicates with the first transceiver to allow access to the drop box. The drop box may include an insulated drop box and a port for connecting to the temperature control unit. The first and second transceivers may include, for example, two-way communication analog chips, and may wirelessly communicate via a radio frequency link.

The inventive system may also include a transport vehicle for transporting the item to its destination. The inventive system may also include a dock to serve as a base for the drop box. Further, the dock and/or the drop box may include a lock mechanism for securing the drop box to the dock. The dock may also include a temperature control unit for controlling a temperature inside the drop box.

The drop box may also include a first memory device for storing a first identification number, and the electronic tag may include a second memory device for storing a second identification number. For example, the first and second memory devices may store delivery data such as a delivery date and delivery time. In addition, the drop box may include a processor for comparing the first identification number and the second identification number, and unlock when the first identification number matches the second identification number. The drop box may also include a signaling device (e.g., light emitting device). For example, the signaling device may be activated when the item arrives at a destination.

The electronic tag may also include an activating device (e.g., switch, button, etc.) to activate a function of the electronic tag. For instance, the activating device may be engaged in order to transmit data from the electronic tag to the drop box. Likewise, the drop box may include an activating device to activate a function of the drop box. This activating device may be engaged in order to transmit data from the drop box to the electronic tag.

The inventive system may also include a container for containing the item(s) of goods. In this case, the electronic tag may be affixed to the container. The electronic tag may also be affixed to an outside portion of the item.

The transport vehicle may be directed to the, drop box using an electronic positioning system. For example, the electronic positioning system may include a global positioning system. In this case, the transport vehicle may include a global positioning system receiver.

The inventive system may also include an access card having a third transceiver, for wirelessly communicating with the second transceiver to access the drop box. The system may also include a base station having a fourth transceiver for wirelessly communicating with the first transceiver in order to distinguish an item on the transport vehicle (e.g., by activating the signaling device on the electronic tag associated with the item).

The transport vehicle may also include a computer system which determines an optimum route for delivering the item. The transport vehicle may also include a loop antenna. The base station wirelessly communicate with the electronic tag using the loop antenna.

An inventive method for unattended delivery of an item of goods includes associating the item with an electronic tag having a first transceiver, transporting the item to a destination, and placing the item in a drop box located at the destination, the drop box including a second transceiver which wirelessly communicates with the first transceiver to allow access to the drop box.

The present invention also includes a programmable storage medium tangibly embodying a program of machine-readable instructions executable by a digital processing apparatus to perform the inventive method for unattended delivery of goods.

With its unique and novel aspects, the claimed invention provides a system and method for unattended delivery which is inexpensive to operate, resulting in lower cost to the delivery company and ultimately to consumers.

### BRIEF DESCRIPTION OF THE DRAWINGS

The foregoing and other purposes, aspects and advantages will be better understood from the following detailed description of a preferred embodiment of the invention with reference to the drawings, in which:

FIG. 1 illustrates a system 100 for unattended delivery according to the claimed invention;

FIGS. 2A and 2B illustrate a drop box 150 used in the inventive system according to the claimed invention;

FIG. 3 illustrates an electronic access card 900 used in the inventive system according to the claimed invention;

FIG. 4A illustrates a switch and FIG. 4B illustrates a keypad, on a drop box used in the inventive system according to the claimed invention;

FIG. 5 illustrates an insulated container 1100 and dock 1120 used in the inventive system according to the claimed invention;

FIG. 6 illustrates a “drop box farm” for securing multiple drop boxes in the inventive system according to the claimed invention;

FIG. 7 illustrates a transport vehicle 180 which may be used to transport an item of goods according to the claimed invention;

FIG. 8 illustrates a container 200 for holding an item to be delivered, according to the claimed invention;

FIG. 9 illustrates an electronic tag 210 used in the inventive system according to the claimed invention;

FIG. 10 illustrates the circuitry of the electronic tag 210 used in the inventive system according to the claimed invention;

FIG. 11 is a flow chart of communications in the inventive system according to the claimed invention;

FIG. 12 illustrates an electronic tag 210 affixed to a item of goods to be delivered in the inventive system according to the claimed invention; and

FIG. 13 is a flow chart illustrating the inventive method according to the claimed invention.

### DETAILED DESCRIPTION OF THE PREFERRED EMBODIMENTS

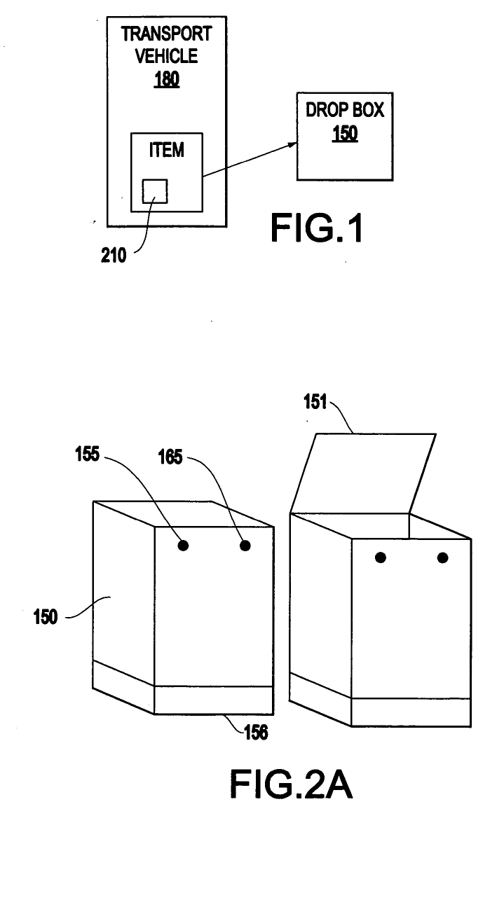

Referring now to the drawings, FIG. 1 illustrates an inventive system 100 for unattended delivery according to the claimed invention.

As shown in FIG. 1, the inventive system 100 includes an electronic tag 210 associated with an item (e.g., plurality of items) of goods to be delivered and including a first transceiver, and a drop box 150 including a second transceiver. The inventive system 100 may also include a transport vehicle 180 for transporting the item of goods to its destination (e.g., to a drop box).

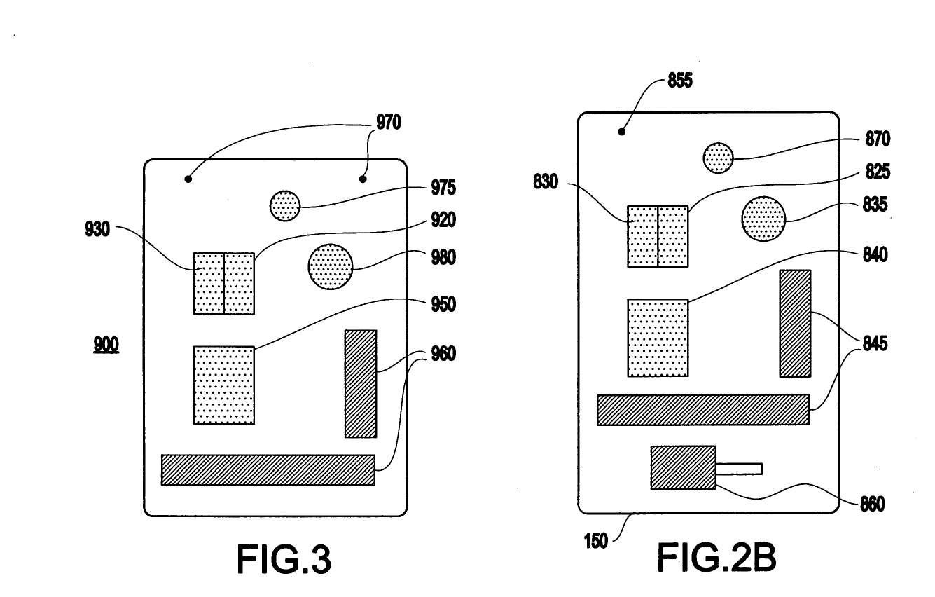

More specifically, as shown in FIG. 2a, the drop box may include an insulated drop box 150 to facilitate the delivery of sensitive (e.g., perishable) goods. The space inside the insulated drop box may range, for example, from between about 1 cubic foot to 30 cubic feet. The temperature inside the box 150 may be controlled to between about 35 and 85 degrees Fahrenheit.

The insulated drop box 150 may also be formed of a variety of materials, such as plastic or metal, and should have good insulative properties. The lid of the box should have a tight seal. In particular, the insulative properties should be sufficient to ensure little energy is required to maintain a temperature inside the insulated drop box 150 within a desirable range. For example, the walls may be formed of a single layer of a conventional insulative material having a sufficient thickness and density to provide the desired insulative features. Alternatively, the box 150 may be double-walled and have insulative material (e.g., a conventional insulative material) therebetween.

In addition, the insulated drop box 150 may also include a door or lid (e.g., hinged door or lid) 151 which may be opened to access the space inside the drop box 150. The insulated drop box 150 may also include a signaling device 155 (e.g., a light-emitting device (e.g., LED) or an audible device) which is activated to signal to the driver where the goods are to be delivered. The box 150 may also include a switch 165 (e.g., a button) located, for example, on the outside of the box to activate and deactivate the security features of the box 150. The box 150 may also be secured to a dock 156 which may be used, for example, to lock the box 150 in a stationary position and provide other features to the box 150 as explained below.

In addition, the insulated drop box 150 could include an optional humidity control feature to regulate the amount of moisture inside the box 150. For example, the humidity inside the box 150 may be controlled so as to remain below 50% relative humidity. To regulate humidity, the box 150 may include a conventional humidity measuring device (e.g., a hygrometer) and a dessicant material (e.g., a conventional dessicant) to remove moisture from the air inside the box 150. Alternatively, the box 150 may include a more extensive humidity control device which may involve air exchanges such as with conventional heating, ventilation and air conditioning (HVAC) systems. Such air exchanges may be desirable, for example, to inhibit the growth of mold or mildew inside the box 150.

In addition, the box 150 could have a switch to activate and deactivate the temperature control and/or humidity control features. Further, the box 150 may have a switch to regulate the temperature and humidity inside the box 150 within desirable ranges. Such switches may be located, for example, on an inside wall of the box. The switches could also be remotely located inside a home or business such as, for example, a home or business which is serviced by the insulated drop box 150.

In addition, as shown in FIG. 2B, the drop box 150 may include, for example, a processor 825 (e.g., a fixed programmed four bit microprocessor), a memory device 830 (e.g., random access memory (RAM)) and a power source 835 (e.g., a lithium battery). The drop box 150 may also include a transceiver 840 (e.g., a custom two-way communication analog chip) and an antenna 845 to transmit and receive data over a short range link. As mentioned above, the power source 835 (e.g., battery) should have a long service life (e.g., over five years) over many (e.g., several thousand) transactions.

Further, the insulated drop box 150 may also optionally include a light-emitting device 855 (e.g., one or two light emitting diodes) that can be optionally used to identify a correct package when a delivery driver arrives. In addition, as shown in FIG. 2B, the antenna 845 in the drop box 150 may include a larger loop antenna for improved two-way communication.

The drop box 150 may further include a lock mechanism 860 having, for example, a low powered motor and a screw that can move a rod forward to lock the lid of the box 150 and rearward to unlock the box 150. Obviously, as would be known by one of ordinary skill in the art taking the present application as a whole, other lid-locking mechanisms could be employed. The box 150 may also have a switch 870 (e.g., a button) to control an operation of the box 150. Further, when the lid is closed, the processor in the drop box 150 automatically causes the lock mechanism 860 to lock the box 150.

The drop box 150 may be used to efficiently used to perform an unattended delivery. For instance, orders are transmitted to a distribution center where the goods are loaded onto a transport vehicle. The transport vehicle 180 for example, may deliver the orders to the specially designed drop-box 150 (e.g., insulated drop box) between about 10:00 pm and 6:00 am when traffic is minimal. Each transport vehicle 180 may be equipped with Global Positioning System guidance that guides the vehicle 180 to the drop box 150 using an optimal route, as well as a wireless communication system that activates a signaling device (e.g., a light emitting diode) on the electronic tag 210 associated with the item to be delivered, as the driver approaches the destination for the item. For instance, the item may be contained in a container which contains the correct order and the electronic tag 210 may be affixed to the container.

Further, the navigation system (e.g., the global positioning system) tells the driver where to stop. The driver may then select the corresponding item (e.g., container) on which the signaling device is activated and deliver the container to the drop box 150.

The driver may open the lid 151 of box 150, remove the goods (i.e., the items ordered) from the container and place them in the insulated drop box 150. The environment control devices (e.g., temperature and humidity control devices) on the drop box 150 ensure that regardless of the weather conditions outside the box 150, the contents of the drop box 150 are safely stored at a safe temperature and/or humidity.

It is important to note that the database in the transport vehicle and the route may be based upon the GPS coordinates of the insulated drop box 150. This makes it possible for the driver to locate the box 150 via a route based system even during the night when it is not possible to see addresses or street signs. This combination of a lockable insulated drop box 150 and GPS coordinates of the box 150 used as the destination makes it possible to do night time deliveries to the box 150 and further reduce costs. Costs are reduced because of reduced traffic and the ability to park almost anywhere, with the added advantage of not requiring signatures or human interaction to successfully make a delivery. Thus, it is possible to do three to four times the number of deliveries using this system than with conventional delivery systems.

As shown in FIG. 3, the inventive system 100 may also include an access card 900 which may be used to access the drop box 150. For instance, instead of using the electronic tag 110 to access the drop box, the deliveryman may use the access card 900. Similarly, after the item has been delivered the drop box 150, the customer (e.g., home or business owner of the destination for the item) may later (e.g., the next morning), open the drop box 150 and remove the goods using an access card 900.

Further, the access card 900 which allows access to the insulated drop box 150 may include a short range wireless link to control a lock mechanism (e.g., a battery operated lock mechanism) contained in the drop box 150. The access card may include an inexpensive processor 920 (e.g., a low powered four bit microprocessor), a memory device 930 (e.g., a random access memory (RAM)) or other nonvolatile memory device for storing a unique identification number. The identification number may be permanent, so that it can be changed only with a special program and transmitter. The access card 900 may also contain a switch 975 (e.g., a button) to control an operation of the access card 900.

The access card 900 may also contain a transceiver 950 (e.g., a transmitter/receiver such as a two-way communication chip) for allowing the access card 900 to communicate with the drop box 800 and other devices in the inventive system 100 (e.g., the base station 120). The two-way communications chip may be, for example, a low-cost CMOS analog digital chip. The two-way communications chip may be connected to orthogonal ferrite antennas 960 that are able to transmit and receive using low frequencies to the loop antenna connected to the base station. Further, the access card 900 may wirelessly communicate with other devices via a bi-directional wireless link. The wireless link may include, for example, a low frequency conductive loop requiring minimal power and allowing communication within a small area. Further, the access card may include display devices 970 (e.g., light emitting diodes) which may be programmed to display both numeric as well as alphanumeric information transmitted to the access card 900. The circuitry may be solar powered or powered, for example, by a battery 980 or other power source. Battery life using conventional alkaline batteries is likely to exceed five years, and with AAA batteries the life maybe longer.

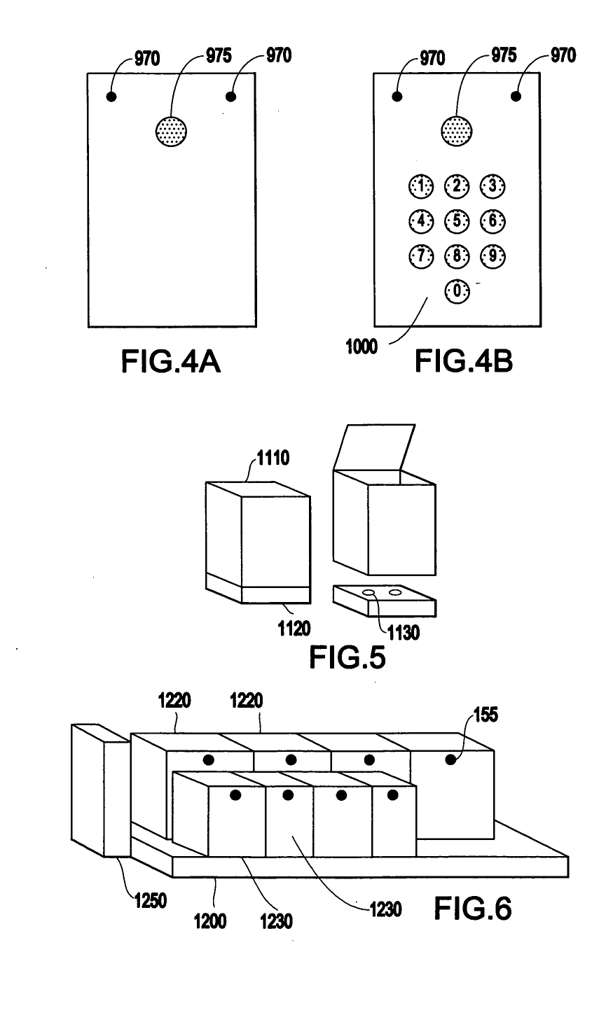

As mentioned above, a record of opening and closing times can be kept in the memory of the drop box 150 so that when the driver opens the box 150 to place an order he can “harvest” this information. Further, as shown in FIG. 4A, the access card 900 might have a single button 975 and one or two display devices 970 (e.g., light emitting diodes) to indicate the status of the box 150.

Alternatively, as shown in FIG. 4B, the box 150 may have a small keypad 1000 to enter in a Personal Identification Number (PIN). The keypad 1000 would allow the driver to program the security level of the access to the box 150 when placing an order using the access card. For instance, if it is a high security item the box 150 could open only with a one time use PIN. For lower security, a standard PIN known by the customer may be used, and for low security items the driver may not enter a PIN.

Further, the access card 900 having a keypad 1000 could also be used by third party couriers, so that each driver might have a PIN. This would make it possible to change the program of the box 150 to disallow the use of a particular PIN, for example, if a driver left the delivery company. In addition, the PIN and keypad 1000 may be used to monitor who accesses the drop box 150.

As shown in FIG. 5, the inventive system 100 may also include an insulated container (e.g., an insulated tote) 1100 which may be used to deliver temperature sensitive items (e.g., perishable goods such as frozen foods). The insulated container 1100 may have a design similar to the insulated drop box 150 described above and may be used to pack sensitive items at a desirable temperature. The insulated container 1100 may have a electronic tag 210 as explained above, affixed thereto. The insulated container 1100 may be loaded at the warehouse and transferred directly to the transport vehicle 180. This eliminates the need for a refrigerated truck.

The insulated container 1100 may be placed, for example, on a dock 1120 which may have the same features as the dock on which the insulated drop box 150 may be stored. Indeed, the dock for the insulated drop box 150 and the insulated container 1100 may be interchangeable. Further, this dock 1120 may be fabricated of heavy concrete and have a locking mechanism 1130 that makes it easy to place the container 1100 or box 150 on the dock 1120 securely.

The driver may therefore, deliver the goods to the destination and remove the goods from the insulated container 1100 and place the goods in the insulated drop box 150. Alternatively (for example, when there exists a dock but no drop box at a destination address) the driver may simply deliver the insulated container 1100 to the destination address and secure it to the dock 1120.

Like the insulated drop box 150, the customer may open the insulated container 1100 with an access card 900 similar to that described above and remove the delivered goods. The driver may return at a later date, open the box with his access card and unlock the insulated container 1100 from the dock by releasing the lock mechanism 1130 from inside the insulated container 1100.

Further, the lock mechanism 1130 on the dock 1120 may interact with the lock mechanism on the drop box 150 as explained above, to secure the drop box 150 or insulated container 1100 to the dock. For instance, the lock mechanism 1130 might have a design similar to a hydraulic quick release coupling used to connect hydraulic lines on heavy equipment. For instance, the lock mechanism 1130 may include a male portion of the coupling, and the lock mechanism in the drop box 150 or container 1100 may include the female portion of the coupling. When the box 150 or container 1100 is positioned on the dock and engaged (e.g., pushed down) the lock mechanisms 860, 1130 would be activated. The user may, for example, open the box 150 or container 1100 and pull back the collar on the coupling to thereby release the drop box or container from the dock.

In addition, the dock 156, 1120 may also be used to house devices for providing the temperature and humidity control features discussed above. In other words, the insulated drop box 150 or container 1100 may be devoid of any active temperature or humidity control devices, but would include merely a port which is attached securely to the dock when the box 150 or container 1100 is secured to the dock. This would allow, for example, heated, chilled or conditioned air to be generated outside the box 150 or container 1100 and fed into the box 150 or container 1100 through the valve to help maintain a desirable temperature and/or humidity. This conditioned air could be generated, for example, using a peltier device contained in the dock or alternatively be remotely generated by a system in a house or business and attached to the dock 156, 1120, for example, via an insulated conduit (e.g., hose).

In addition, as shown in FIG. 6, the present invention may include a multi-port dock 1200 which may be used, for example, in an apartment complex or business office. As shown in FIG. 6, the multi-port dock 1200 may be able to accommodate boxes of different sizes (e.g., large boxes 1220 and small boxes 1230). The multi-port dock 1200 may also include an access console 1250 for controlling an access to all boxes in on the dock 1200. Further, a single access key point might be created on one box so that a user would take the access card and push the button near that point. The box with that customer's order would activate a signaling device 155 (e.g., an LED) to indicate that it is open and that it contains that customer's order.

This “box farm” design has many unexpected advantages. It offers attractive economics because a driver can drop many items to a single GPS address and increase his nightly throughput. The design may, for example, be a part of a conventional locker type system located in a building lobby.

The inventive system 100 is fully integrated and solves the problems of conventional systems, thereby making sales (e.g., internet sales) and unattended delivery of items such as groceries and dry goods commercially feasible. For instance, the inventive system 100 may also include an ordering device (e.g., an internet-based ordering device). Consumers may, for example, use such an ordering device (e.g., a personal computer which is connected to the internet) to place orders quickly. For example, with an internet-based ordering device, a customer may view an image of the product and place an order directly over the internet. Such orders from the ordering device may be received, for example, at a distribution center which distributes the goods to fill the orders.

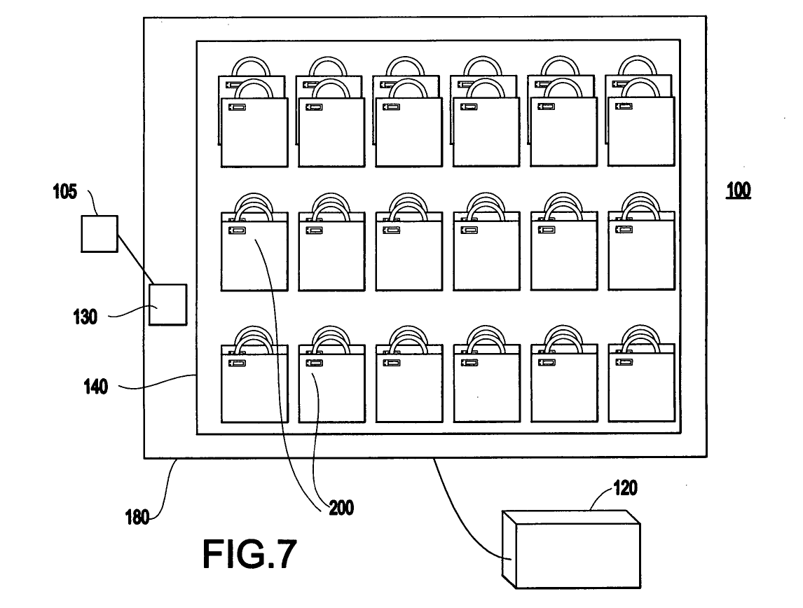

As shown in FIG. 7, the inventive system 100 may also include a transport vehicle 180 which may be used to deliver the item of goods to the drop box 150. For example, the inventive system 100 may select an optimum route for the driver of the transport vehicle 180, identify the correct goods to be delivered at each destination, and verify that the goods were actually delivered.

More specifically, as shown in FIG. 7, the inventive system 100 may utilize a two-way inductive wireless communication system to help guide the transport vehicle 180 to the drop box 150. For instance, the inventive system 100 may use an electronic positioning system (e.g., global positioning system) 105 to verify the location of the transport vehicle 180. The inventive system 100 may also include a computer system 130 which may be located on the transport vehicle 180. The computer system 130 may wirelessly communicate with a base station 120 to optimize a delivery route. Further, the computer system 130 may monitor the location of the transport vehicle using the global positioning system (GPS) 105 (e.g., a GPS receiver may be located on the transport vehicle). The GPS may also be used to locate the drop box 150 and the transport vehicle's position relative to the drop box 150. The transport vehicle 180 may also include a loop antenna 140 to facilitate a two way communication with the base station 120.

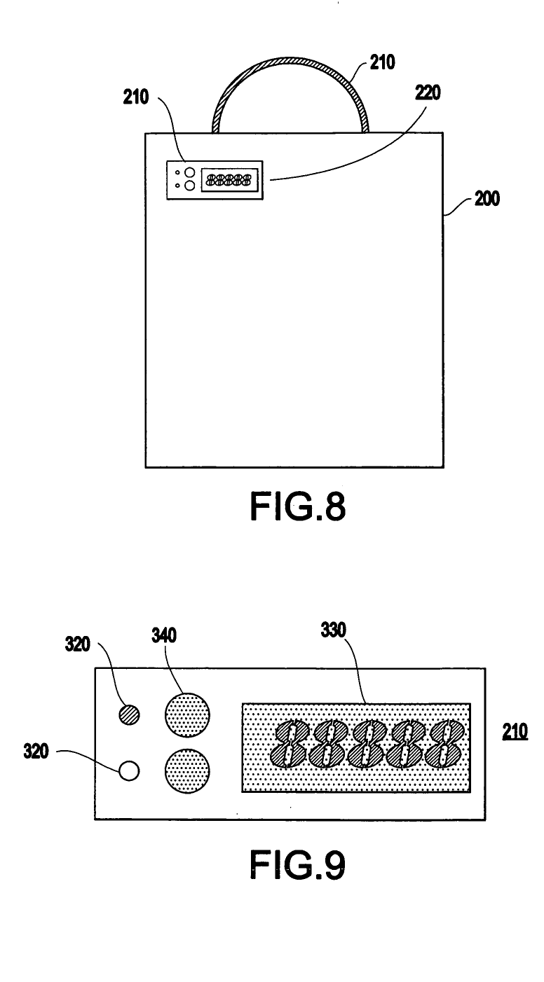

As noted above, the electronic tag 210 associated with the goods may be affixed to a container (e.g., containers) 200 (e.g., a bag or tote). As shown in more detail in FIG. 8, the containers 200 may be made from materials such as cloth (e.g., canvas) or plastic (e.g., nylon), and may include a support device 211 (e.g., a support strap) attached to the container 200 (e.g. at the top of the container) which makes it easy to lift, carry and store the container 200.

Further, as shown in FIG. 9, the small electronic tag 210 (e.g., electronic module) may be located, for example, in a small translucent pocket 220 on the container 200. The tag may include a signaling device (e.g., a plurality of signaling devices) such as a colored (e.g., red or green) light emitting device 320 (e.g., a light emitting diode (LED) or an audible signaling device. The electronic tag 210 may also include a liquid crystal display 330 (LCD) for numeric or alphanumeric display, and a switch (e.g., plurality of switches or buttons) 340 for controlling an operation of the electronic tag 210.

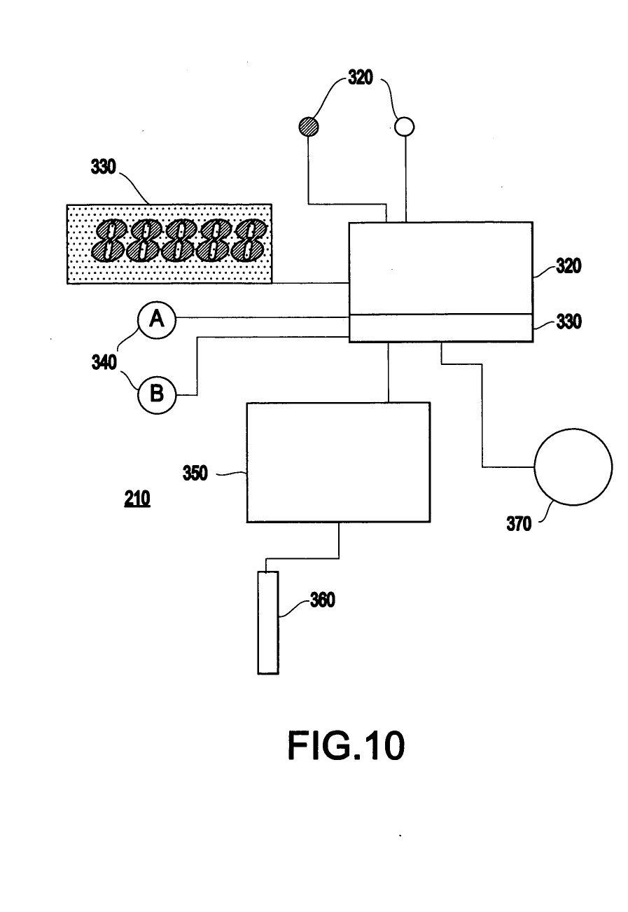

FIG. 10 provides a more detailed description of the electronic tag 210. As shown in FIG. 10, the electronic tag 210 additionally may include an inexpensive processor 320 (e.g., a low powered four bit microprocessor), a memory device 330 (e.g., a random access memory (RAM)) or other nonvolatile memory device for storing a unique identification number. The identification number may be permanent, so that it can be changed only with a special program and transmitter.

The electronic tag 210 may also contain a transceiver 350 (e.g., a transmitter/receiver such as a two-way communication chip) for allowing the electronic tag 210 to communicate with the base station 120 (and the drop box 150). The two-way communications chip may be, for example, a lowcost CMOS analog digital chip. The chip may be connected to orthogonal ferrite antennas 360 that are able to transmit and receive signals using low frequencies to the loop antenna (e.g., in the transport vehicle) wirelessly connected to the base station 120.

Further, a loop antenna 140 may be located on the transport vehicle 180 in order to facilitate a two way communication between the electronic tag(s) 210 and the base station 120. Specifically, the electronic tag 210 may wirelessly communicate with the base station 120 via a bi-directional wireless link. The wireless link may include, for example, a low frequency conductive loop requiring minimal power and allowing communication within a small area. Further, the LCD 330 may be programmed to display both numeric as well as alphanumeric information transmitted to the electronic tag (e.g., electronic module) via the base station 120. The circuitry may be solar powered or powered, for example, by a battery 370 or other power source. Battery life using conventional alkaline batteries is likely to exceed five years, and with AAA batteries the life may be longer.

In the inventive system 100, the container 200 may be loaded with an item (e.g., items) of goods, for example, at a distribution center or warehouse facility. The items may then be transferred onto a transport vehicle where the items are sorted and placed (e.g., on shelves) in the transport vehicle 180. The location of the items (e.g., items in containers) on the transport vehicle can be random or predetermined. For example, the electronic tag 210 may be used to help direct the placement of items at predetermined locations on the transport vehicle. For example, a item's proper location on the transport vehicle 180 may be displayed on the LCD 330 so that it may be easily viewed, for example, by handlers (e.g., picker/packers) at the distribution center. For instance, the items may be sorted and shelved on the transport vehicle 180, for example, by destination.

Further, the location of an item (e.g., location code) may be determined so as to minimize driver time. For example, the location may be determined based upon, for example, the route the transport vehicle 180 must take to deliver all the packages. For example, the items can be placed from left to right, front to back, upper to lower or lower to upper or in any other order, according to such factors as the destination of the item or the anticipated time of delivery. For example, the earliest or closest deliveries may start on the lower left side of the transport vehicle 180 and proceed up and right along the wall of the transport vehicle 180 so that the latest or farthest deliveries would be located on the lower right side of the transport vehicle 180. Therefore, the delivery driver does not have to know what item is to be delivered to a particular destination. Instead, the driver may make a delivery knowing, for example, an item located at a particular location on the transport vehicle 180 is to be delivered to a particular destination.

In addition, using the loop antenna 140, the base station 120 may poll all of the electronic tags 210 in the inventive system 210 in search of a particular electronic tag 210 and communicate only with that particular tag. For instance, the base station 120 may poll each of the electronic tags 210 located near (e.g., within) the loop antenna 140 on the transport vehicle 180. Thus, the base station 120 is capable of placing specific information on the display 330, activating/deactivating the signaling device (e.g., flashing the light emitting diodes 320), selectively activating each electronic tag 210 associated with an item of goods to be delivered (e.g., an electronic tag 210 affixed to a container which contains items to be delivered).

For instance, the GPS coordinates of each delivery address may be known in advance. The items (e.g., containers of items) to be delivered may be loaded onto racks at a distribution center and placed in the transport vehicle 180. The loop antenna 140 may, for example, be wired around the back and/or top of the rack holding the items (e.g., containers). The loop antenna 140 is wirelessly connected to the base station 120 which can transmit and receive to all electronic tags 210 contained in the loop.

Each electronic tag 210 may have a unique identification number. The base station 120 may poll all of the electronic tags 210 in the loop (e.g., in the transport vehicle) for a specific identification number, and then communicate only to that specific electronic tag. For example, the base station may place specific information on the display of the electronic tag, activate or deactivate the signaling device (e.g., LED) while selectively polling each electronic tag.

The containers may be packed in an optimal manner at the distribution center using a similar arrangement. In this application, an optimal route has been calculated using the electronic positioning system (e.g., global positioning system) 105 for each destination for each container. A sequence number may be displayed on each electronic tag 210 indicating the relative positions for items (e.g., containers) in the transport vehicle. Alternatively, the route may be calculated and a specific position for placing the item to be delivered (e.g., an item in a container) in the transport vehicle may be displayed on the electronic tag's display (e.g., LCD). Further, the item with the first destination may be placed on the first rack, on the first hook, the second item can be placed on the same rack on the same hook, a third item on the next hook, and so on. These shelf positions may be indicated by a sequence of digits, one-one, one-two, and so on.

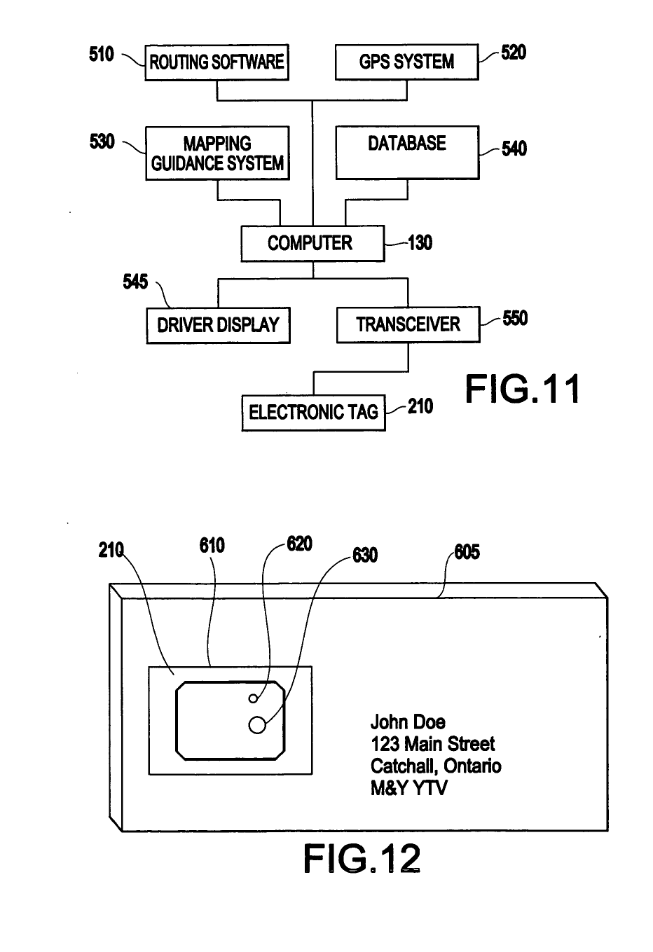

Further, the inventive system 100 may include several hardware and software components. As shown in FIG. 11, routing software 510 (e.g., executed by the computer system 130) may be used to calculate an optimal route based on the GPS coordinates of the address is where items are to be delivered. The global positioning system 520 (GPS), may detect the location of a transport vehicle 180 in realtime. A mapping guidance system 530 may also be used to direct the driver to the correct address. This is particularly important if the system is used for nighttime delivery when addresses and street signs are not normally visible. A database 540 holding the correct item (e.g., container) and the ID for the tag associated with the item plus the GPS address is also stored in the computer system 130.

The computer system 130 may also include, for example, a display 545 (e.g., a laptop computer with a flat panel display) which is temporarily located near the delivery driver in the transport vehicle 180. In addition, the computer system 130 may include a transceiver (e.g., a transmitter/receiver) 550 for wirelessly communicating with the base station 120. The base station 120 similarly may include a transceiver (e.g., a transmitter/receiver) allowing it to wirelessly communicate with all of the electronic tags 210 in the inventive system 100 by the unique ID number of the tags. Thus, the inventive system 100 can activate a signaling device (e.g., an LED) on a particular container 200 or package when the delivery driver arrives at the destination for that particular package.

The inventive system 100 may also determine an optimal route for the transport vehicle 180. An optimal route may be used, for example, to minimize time or distances traveled by the transport vehicle. The optimal route may be determined, for example, using the electronic positioning system 105 (e.g., GPS) and the coordinates or addresses of each item's destination. The optimal route may be, for example, input into the computer system 130 which may also be located on the transport vehicle. The ID numbers of the electronic tags 210 can also be loaded into the computer system 130. The GPS system can also be used to guide the transport vehicle to an item's destination via a map, or other conventional routing software. When the transport vehicle arrives at an item's destination, the computer system 130 can alert the driver, for example, audibly or by displaying a text message on the computer system display 545. The message to the driver may include, for example, the destination address, the number of packages to be delivered, and the package's location on the transport vehicle 180.

In addition, the computer system 130 (or the base station 120 by using the loop antenna 140) may cause the electronic tag 210 associated with the item to be delivered (e.g., the tag affixed to the container 200 housing the item), to be activated so as to facilitate locating the item by the driver. For example, the signaling device (e.g., light emitting device or audible device or combination thereof) on the electronic tag 210 may be activated so that the driver can easily locate the item. The driver need only locate the item with the activated signal (e.g., a flashing light), remove the item from its container (if applicable) and deliver it to its destination.

The driver may also activate the switch 340 (e.g., a button) on the electronic tag 210 to indicate that the item has been properly delivered to its destination. In addition, if for some reason the item could not be delivered, the driver may place the item back into the container and activate a switch (e.g., on the electronic tag) to indicate that delivery was attempted but unsuccessful.

Further, additional information can be displayed on the LCD 330 of the electronic tag 210 at different times. For example, after the container 200 is loaded on the transport vehicle, the number of items contained in the container 200 can be displayed so the driver can periodically check the contents of each container 200.

Furthermore, when the container 200 is empty, the driver may deactivate the electronic tag 210 using an activation switch 340 (e.g., a button) on the electronic tag 210. The electronic tag 210 may also be automatically deactivated, for example, by placing the container 200 and/or the electronic tag 210 at a particular location on the transport vehicle 180 which may house a short-range antenna emitting a deactivation signal. In addition, the computer system 130 wirelessly communicates with the electronic tag 210 and may, therefore, detect that the container 200 is no longer in use.

The container 200 used by the inventive system may include, for example, a tote (e.g., a plastic tote). In this case, the electronic tag may be located, for example, on the front of the tote. In addition, a simple, inexpensive electronic tag may contain a single LED to facilitate locating the package by the delivery driver.

Further, as shown in FIG. 12, a small electronic tag 210 may be placed, for example, not on the container but instead, directly on the item 605 to be delivered. In this case, the driver may remove the tag 210 as the item is delivered to its destination, and place the tag in a special bin located, for example, in the transport vehicle. Further, the electronic tag 210 may be placed on the package using an adhesive pouch 610 having a plastic window. Tag 210 might be very flat like a credit card with only a single light emitting diode 620, and a small switch 630 (e.g., button) and in all other respects is the same as the electronic tag 210 in FIGS. 9 and 10. The switch 630 may be used for confirmation delivery, or alternatively to allow the tag 210 to be used as an access card to open an electronic drop box at the package's destination.

For example, the driver may activate the switch 630 (e.g, push a button) on the tag to gain access to the drop box. The tag 210 on the item 605 wirelessly communicates with the drop box 150 causing the drop box 150 to unlock. After the driver places the item 605 in the drop box 150, the tag 210 may be removed and placed in a bin located, for example, on the transport vehicle 180. In addition, the driver may deactivate the tag 210 to indicate that the tag 210 is no longer in use and/or that the item 605 was properly delivered, using the switch 630 on the electronic tag 210. Further, the tag 210 may include a memory which records, for example, the date and time that the tag was used to open the drop box 150.

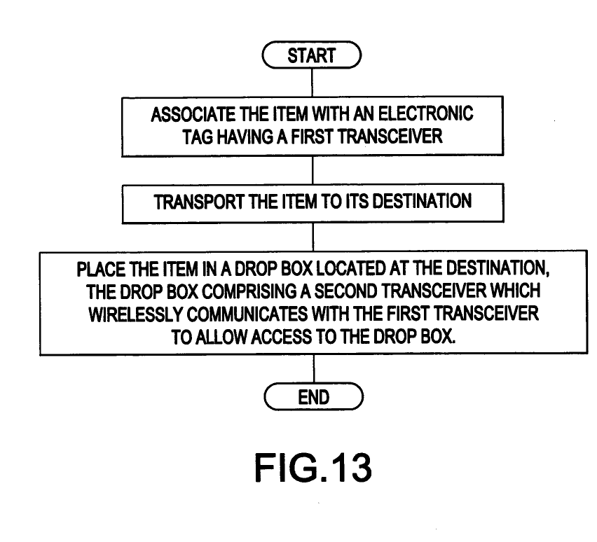

Referring again to the drawings, FIG. 13 provides a flowchart illustrating an inventive method 130 for unattended delivery of goods. As shown in FIG. 13, the inventive method 1300 includes associating 1310 an item to be delivered with an electronic tag including a first transceiver, transporting 1320 the item to a destination, and accessing 1330 a drop box located at the destination, the drop box including a second transceiver.

With its unique and novel aspects, the claimed invention provides a system and method for unattended delivery which is inexpensive to operate, resulting in lower cost to the delivery company and ultimately to consumers.

While a preferred embodiment of the present invention has been described above, it should be understood that it has been provided as an example only. Thus, those skilled in the art will recognize that the invention can be practiced with modification within the spirit and scope of the appended claims. For instance, although the invention is described in terms of unattended delivery, it may also be used for attended delivery as well.

1. A system for unattended delivery of an item comprising:
an electronic tag associated with said item and comprising a first transceiver; and
a drop box located at a destination for said item, said drop box comprising a second transceiver which wirelessly communicates with said first transceiver to allow access to said drop box.

2. The system according to claim 1, further comprising:
a dock to serve as a base for said drop box.

3. The system according to claim 2, wherein at least one of said dock and said drop box comprises a lock mechanism for securing said drop box to said dock.

4. The system according to claim 2, wherein said dock comprises a temperature control unit for controlling a temperature inside said drop box, and wherein said drop box comprises an insulated drop box and a port for connecting to said temperature control unit.

5. The system according to claim 1, wherein said drop box further comprises a first memory device for storing a first identification number, and wherein said electronic tag further comprises a second memory device for storing a second identification number.

6. The system according to claim 1, wherein said drop box further comprises a processor for comparing said first identification number and said second identification number, and wherein said drop box unlocks when said first identification number matches said second identification number.

7. The system according to claim 1, wherein said first and second transceivers each comprise a two-way communication analog chip.

8. The system according to claim 1, wherein said electronic tag further comprises an activating device to activate a function of said electronic tag.

9. The system according to claim 8, wherein said activating device is engaged in order to transmit data from said electronic tag to said drop box.

10. The system according to claim 1, wherein said drop box further comprises an activating device to activate a function of said drop box.

11. The system according to claim 10, wherein said activating device is engaged in order to transmit data from said drop box to said electronic tag.

12. The system according to claim 5, wherein said first and second memory devices store delivery data comprising a delivery date and delivery time.

13. The system according to claim 1, wherein said electronic tag is affixed to an outside portion of said item.

14. The system according to claim 1, further comprising:
a transport vehicle for delivering said item to said destination.

15. The system according to claim 14, wherein said a transport vehicle is directed to said drop box using electronic positioning system.

16. The system according to claim 15, wherein said electronic positioning system comprises
a global positioning system, and wherein said transport vehicle comprises a global positioning system receiver.

17. The system according to claim 1, wherein said first transceiver wirelessly communicates with said second transceiver via a radio frequency link.

18. The system according to claim 1, further comprising:
a container for containing said goods,
wherein said electronic tag is affixed to said container.

19. The system according to claim 1, further comprising:
an access card comprising a third transceiver, for wirelessly communicating with said second transceiver to access said drop box.

20. The system according to claim 1, wherein said drop box further comprises a signaling device and wherein said signaling device is activated when said item arrives at a destination.

21. The system according to claim 14, wherein said transport vehicle comprises a computer system which determines an optimum route for delivering said item.

22. The system according to claim 14, further comprising:
a base station comprising a fourth transceiver for wirelessly communicating with said first transceiver while said item is on said transport vehicle.

23. The system according to claim 22, wherein said transport vehicle comprises a loop antenna, and wherein said base station wirelessly communicates with said electronic tag using said loop antenna.

24. An insulated drop box for a delivery system, comprising:
an insulated housing for receiving an item of goods; and
a transceiver for wirelessly communicating with an electronic tag in order to access said drop box.

25. A method for unattended delivery of an item of goods comprising:
associating said item with an electronic tag comprising a first transceiver;
transporting said item to a destination; and
placing said item in a drop box located at said destination, said drop box comprising a second transceiver which wirelessly communicates with said first transceiver to allow access to said drop box.

26. A programmable storage medium tangibly embodying a program of machine-readable instructions executable by a digital processing apparatus to perform a method for unattended delivery of goods, said method comprising:
associating said item with an electronic tag comprising a first transceiver;
transporting said item to a destination; and
placing said item in a drop box located at said destination, said drop box comprising a second transceiver which wirelessly communicates with said first transceiver to allow access to said drop box.
